(19) United States
(12) Patent Application Publication
(10) Pub. No.: US 2012/0242654 A1
(43) Pub. Date: Sep. 27, 2012

(54) METHOD OF CONTROLLING LIQUID CRYSTAL SHUTTER GLASSES AND DISPLAY SYSTEM FOR PERFORMING THE SAME

(75) Inventors: Young-Su HAN, Incheon (KR); Gyeong-Ub MOON, Asan-si (KR); Jung-Hwan CHO, Asan-si (KR)

(73) Assignee: SAMSUNG ELECTRONICS CO., LTD., Suwon-si (KR)

(21) Appl. No.: 13/241,460

(22) Filed: Sep. 23, 2011

(30) Foreign Application Priority Data
Mar. 25, 2011 (KR) 2011-0026785

(51) Int. Cl. G06T 15/00

(52) U.S. Cl. 345/419

(57) ABSTRACT

A method of controlling liquid crystal (LC) shutter glasses includes: generating a three-dimensional (3D) stereoscopic image synchronization signal based on left eye image data and right eye image data; generating left eye shutter control data and right eye shutter control data synchronized with the 3D stereoscopic image synchronization signal, where the left eye shutter control data and the right eye shutter control data are in digital form; modulating the left eye shutter control data and the right eye shutter control data to generate a shutter control signal; and controlling the LC shutter glasses based on the shutter control signal.

This application claims priority to Korean Patent Application No. 2011-0026785, filed on Mar. 25, 2011, and all the benefits accruing therefrom under 35 U.S.C. §119, the content of which in its entirety is herein incorporated by reference.

### BACKGROUND OF THE INVENTION

1. Field of the Invention

Exemplary embodiments of the invention relate to a method of controlling liquid crystal (“LC”) shutter glasses and a display system for performing the method. More particularly, exemplary embodiments of the invention relate to a method of controlling LC shutter glasses used for a display apparatus and a display system for performing the method.

2. Description of the Related Art

Generally, a display apparatus displays a two-dimensional (“2D”) image. Recently, a demand for a three-dimensional (“3D”) stereoscopic image has been increased in fields of games and movies, for example, such that the display apparatus for displaying the 3D stereoscopic image has been developed.

The 3D stereoscopic image is typically displayed using a binocular parallax principle through both eyes. As for methods using the binocular parallax, a stereoscopic type and an auto-stereoscopic type are provided. The stereoscopic type may be divided into an anaglyph type using blue and red glasses for two eyes, respectively, and a liquid crystal (“LC”) shutter glasses type in which each of a left image for a left eye and a right image for a right eye is periodically displayed with a certain interval, and glasses for opening and closing LC shutters for the left and right eyes synchronized with the interval are used.

In the LC shutter glasses type, a display apparatus is typically connected to a transmitter that transmits a signal to an LC shutter glasses, and the LC shutter glasses includes a receiver that remotely receives the signal.

Generally, the transmitter is an infrared light (“IR”) transmitter, and the receiver is an IR receiver. The transmitter is connected to a timing control part of the display apparatus to generate and transmit a left eye shutter control signal and a right eye shutter control signal synchronized with the a 3D stereoscopic image synchronized signal provided from the timing control part. The receiver receives the left eye shutter control signal and the right eye shutter control signal to open and close the left eye shutter and the right eye shutter.

However, the left eye shutter control signal and the right eye shutter control signal include signals opening the left eye shutter and the right eye shutter, respectively, such that a crosstalk between a left eye image and a right eye image may occur. The left eye shutter control signal and the right eye shutter control signal also include complicated pulse width patterns, respectively, such that the LC shutter glasses may misrecognize the complicated pulse width patterns. Thus, a visual characteristic of the display apparatus may deteriorate.

### BRIEF SUMMARY OF THE INVENTION

Exemplary embodiments of the invention provide a method of controlling liquid crystal (“LC”) shutter glasses which improves a visible characteristic of a display apparatus.

Exemplary embodiments of the invention further provide a display system for performing the method.

According to an exemplary embodiment of the invention, a method of controlling LC shutter glasses includes: generating a three-dimensional (3D) stereoscopic image synchronization signal based on left eye image data and right eye image data; generating left eye shutter control data and right eye shutter control data synchronized with the 3D stereoscopic image synchronization signal, where the left eye shutter control data and the right eye shutter control data are in digital form; modulating the left eye shutter control data and the right eye shutter control data to generate a shutter control signal; and controlling the LC shutter glasses based on the shutter control signal.

In an exemplary embodiment, the generating the left eye shutter control data and the right eye shutter control data may include generating the left eye shutter control data when the 3D stereoscopic image synchronized signal has a high level, and generating the right eye shutter control data when the 3D stereoscopic image synchronized signal has a low level.

In an exemplary embodiment, the generating the left eye shutter control data when the 3D stereoscopic image synchronized signal has the high level may include generating left eye open data corresponding to an opening of a left eye shutter of the LC shutter glasses at a first timing of a high period, during which the 3D stereoscopic image synchronized signal has the high level, and generating left eye close data corresponding to a closing of the left eye shutter of the LC shutter glasses at a second timing delayed from the first timing

In an exemplary embodiment, the generating the right eye shutter control data when the 3D stereoscopic image synchronized signal has the low level may include generating right eye open data corresponding to an opening of a right eye shutter of the LC shutter glasses at a third timing of a low period, during which the 3D stereoscopic image synchronized signal has the low level, and generating right eye close data corresponding to a closing of the right eye shutter of the LC shutter glasses at a fourth timing delayed from the third timing.

In an exemplary embodiment, the generating the left eye shutter control data when the 3D stereoscopic image synchronized signal has the high level may include generating left eye open data corresponding to an opening of a left eye shutter at a first timing of a high period in which the 3D stereoscopic image synchronized signal has the high level, and generating left eye open time control data corresponding to a controlling of an open time of the left eye shutter at a second timing delayed from the first timing. The generating the right eye shutter control data when the 3D stereoscopic image synchronized signal has the low level may include generating right eye open data corresponding to an opening of a right eye shutter at a third timing of a low period in which the 3D stereoscopic image synchronized signal has the low level, and generating right eye open time control data corresponding to a controlling of an open time of the right eye shutter at a fourth timing delayed from the third timing.

According to another exemplary embodiment of the invention, a display system includes a timing control part which generates a three-dimensional (3D) stereoscopic image synchronized signal based on left eye image data and right eye image data, and generates left eye shutter control data and right eye shutter control data in digital form synchronized with the 3D stereoscopic image synchronized signal, a display panel which displays a 3D stereoscopic image using the left eye image data and the right eye image data, a transmitter which modulates the left eye shutter control data and the right eye shutter control data to generate a shutter control signal and a receiver which controls a left eye shutter and a right eye shutter based on the shutter control signal.

In an exemplary embodiment, the timing control part may include a synchronized signal generating part which receives the left eye image data and the right eye image data, and generates the 3D stereoscopic image synchronized signal based on the left eye image data and the right eye image data and a memory which stores the left eye shutter control data and the right eye shutter control data, where the timing control part reads the left eye shutter control data when the 3D stereoscopic image synchronized signal has a high level, and reads the right eye shutter control data when the 3D stereoscopic image synchronized signal has a low level.

In an exemplary embodiment, the left eye shutter control data may include a left eye open data corresponding to an opening of the left eye shutter and a left eye close data corresponding to a closing of the left eye shutter, And the timing control part may read the left eye open data at a first timing of a high period, during which the 3D stereoscopic image synchronized signal has the high level, and may read the left eye close data at a second timing delayed from the first timing.

In an exemplary embodiment, the right eye shutter control data may include a right eye open data corresponding to an opening of the right eye shutter and a right eye close data corresponding to a closing of the right eye shutter, and the timing control part may read the right eye open data at a third timing of a low period, during which the 3D stereoscopic image synchronized signal has the low level, and may read the right eye close data at a fourth timing delayed from the third timing.

In an exemplary embodiment, the left eye shutter control data may include a left eye open data corresponding to an opening of the left eye shutter and a left eye shutter open time control data corresponding to a controlling of an open time of the left eye shutter, the right eye shutter control data may include a right eye open data corresponding to an opening of the right eye shutter and a right eye shutter open time control data corresponding to a controlling of an open time of the right shutter, and the timing control part may read the left eye open data at a first timing of a high period in which the 3D stereoscopic image synchronized signal has the high level, read the left eye shutter open time control data at a second timing delayed from the first timing, read the right eye open data at a third timing of a low period in which the 3D stereoscopic image synchronized signal has the low level and read the right eye shutter open time control data at a fourth timing delayed from the third timing.

According to an exemplary embodiment of a method of controlling shutter glasses and a display system for performing the method, a timing control part provides shutter control data in digital form from an external device to the transmitter, such that the transmitter may generate a simple shutter control signal.

In an exemplary embodiment, the transmitter transmits the simple shutter control signal to a receiver, such that the receiver has a simple structure.

In an exemplary embodiment, the opening and the closing of a left eye shutter and a right eye shutter is controlled using the shutter control data, such that the left eye shutter is effectively prevented from being open during the right eye shutter is open.

In an exemplary embodiment, the opening and the open time of the left eye shutter and the right eye shutter are controlled using the shutter control data, such that a visible characteristic is substantially improved. Thus, the open timing of the left eye shutter and the right eye shutter is effectively optimized

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram illustrating an exemplary embodiment of a display system for performing an exemplary embodiment of a method of controlling liquid crystal (“LC”) shutter glasses according to the invention;

FIG. 2 is a block diagram illustrating a exemplary embodiment of a timing control part, a transmitter and a receiver of FIG. 1;

FIG. 3 is a signal timing diagram illustrating an exemplary embodiment of a stereoscopic image synchronization signal and a shutter controlling signal in the display system of FIG. 1;

FIG. 4 is a flow chart illustrating an exemplary embodiment of a method of controlling the LC shutter glasses of FIG. 1; and

FIG. 5 is a signal timing diagram illustrating a stereoscopic image synchronization signal and a shutter controlling signal in an alternative exemplary embodiment of a display system.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, “connected” includes physically and/or electrically connected. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be explained in detail with reference to the accompanying drawings.

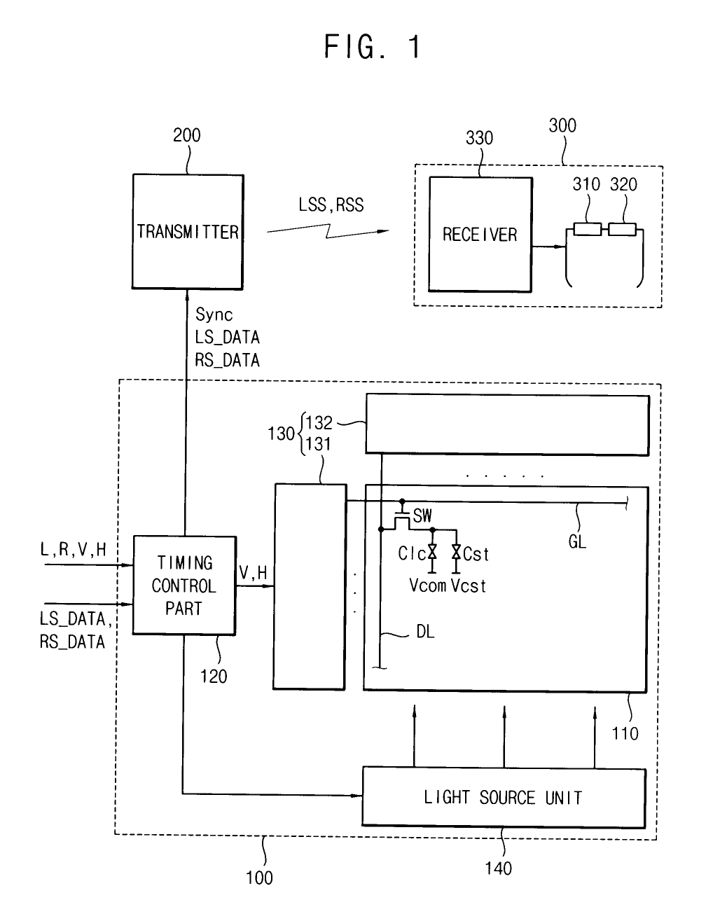

FIG. 1 is a block diagram illustrating an exemplary embodiment of a display system for performing an exemplary embodiment of a method of controlling a shutter glasses according to the invention.

Referring to FIG. 1, a display system includes a display apparatus 100, a transmitter 200 and liquid crystal (“LC”) shutter glasses 300. The display system is embodied to view a three-dimensional (“3D”) stereoscopic image displayed on the display apparatus 100 using the LC shutter glasses 300.

The display apparatus 100 includes a display panel 110, a timing control part 120, a display driving part 130 and a light source unit 140. The display apparatus 100 display a two-dimensional (“2D”) image and the 3D stereoscopic image.

The display panel 110 includes a gate line GL extending in a first direction, a data line DL extending in a second direction crossing the first direction, and a pixel driven by signals provided from the gate line GL and the date line DL. The pixel includes a switching element SW electrically connected to the gate line GL and the date line DL, a liquid crystal capacitor Clc connected to the switching element SW, and a storage capacitor Cst connected to the liquid crystal capacitor Clc.

The timing control part 120 provides timing signals of controlling an image displayed on the display panel 110 to the display driving part 130. In one exemplary embodiment, for example, the timing control part 120 receives the 3D stereoscopic image data L and R, a control signal V and H, and shutter control data LS_DATA and RS_DATA from an external device to provide the 3D stereoscopic image data L and R, the control signal V and H and the shutter control data LS_DATA and RS_DATA to the display driving part 130 and the transmitter 200.

The shutter control data LS_DATA and RS_DATA includes left eye shutter control data LS_DATA corresponding to an opening of a left eye shutter of the LC shutter glasses 300 when the left eye image data are displayed on the display panel 110, and right eye shutter control data RS_DATA corresponding to an opening of a right eye shutter of the LC shutter glasses 300 when the right eye image data are displayed on the display panel 110. Each of the left eye shutter control data LS_DATA and the right eye shutter control data RS_DATA may be in digital form including bit strings.

The display driving part 130 includes a gate driving part 131 and a data driving part 132. The gate driving part 131 may include a plurality of gate driver chips. The gate driving part 131 provides a gate on/off signal to the gate line GL of the display panel 110.

The data driving part 132 may include a plurality of data driver chips. The data driving part 132 provides left eye image data L and right eye image data R to the data line DL of the display panel 110.

The light source unit 140 provides light to the display panel 110. The light source unit 140 may receive a signal for driving a light source based on the left eye image data L and the right eye image data R from the timing control part 120.

The transmitter 200 may be disposed outside the display apparatus 100 and electrically connected to the display apparatus 100 through a cable, or may be disposed inside the display apparatus 100 and electrically connected to the display apparatus 100. The transmitter 200 receives the shutter control data LS_DATA and RS_DATA and the 3D stereoscopic image synchronized signal from the timing control part 120 to remotely transmit the shutter control signal SCS to the LC shutter glasses 300. The shutter control signal SCS includes a left eye shutter control signal LSS and a right eye shutter control signal RSS.

The LC shutter glasses 300 include a left eye shutter 310, a right eye shutter 320 and a receiver 330. The receiver 330 receives the shutter control signal SCS from the transmitter 200.

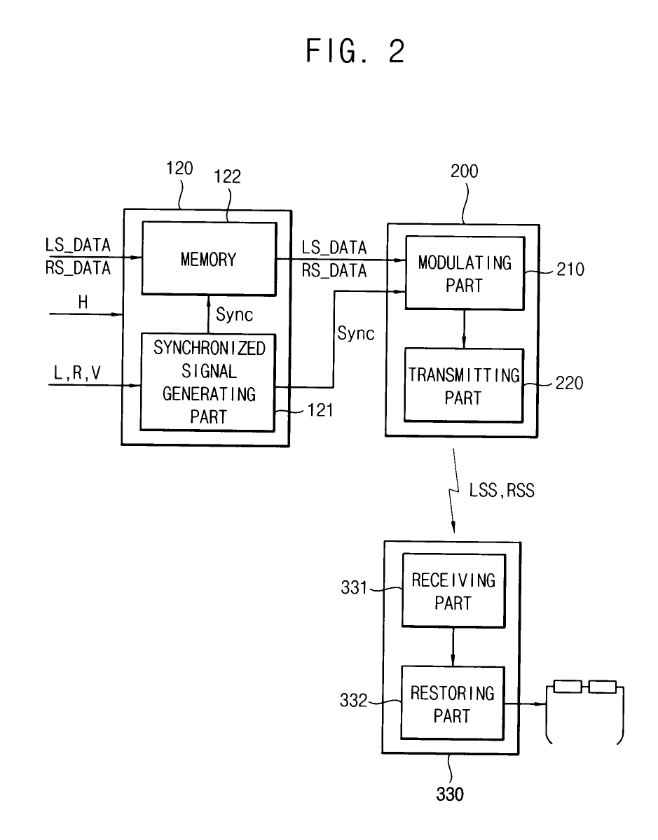

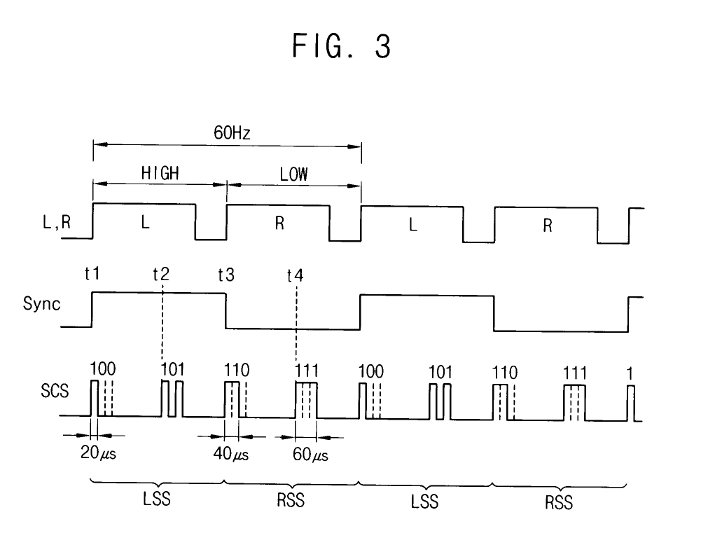

FIG. 2 is a block diagram illustrating an exemplary embodiment of a timing control part, a transmitter and a receiver of FIG. 1. FIG. 3 is a signal timing diagram illustrating an exemplary embodiment of a stereoscopic image synchronization signal and a shutter controlling signal of FIG. 1.

Referring to FIGS. 2 and 3, the timing control part 120 may include a synchronized signal generating part 121 and a memory 122.

The synchronized signal generating part 121 receives the left eye image data L, the right eye image data R and the vertical synchronized signal V from the external device. The synchronized signal generating part 121 generates a 3D synchronized signal Sync based on the left eye image data L, the right eye image data R and the vertical synchronized signal V. In one exemplary embodiment, for example, the 3D synchronized signal Sync may be driven at 60 hertz (Hz). The 3D synchronized signal Sync may have a high level when the left eye image data L are displayed, and may have a low level when the right eye image data R are displayed.

The memory 122 may receive and store the left eye shutter control data LS_DATA and the right eye shutter control data RS_DATA in digital form from an external device. The timing control part 120 may read the left eye shutter control data LS_DATA when the 3D synchronized signal Sync has the high level, and may read the right eye shutter control data RS_DATA when the 3D synchronized signal Sync has the low level.

In one exemplary embodiment, for example, the timing control part 120 may read left eye open data corresponding to an opening of the left eye shutter 310 at a first timing t1 of a high period in which the 3D synchronized signal Sync has the high level, and the timing control part 120 may read left eye close data corresponding to a closing of the left eye shutter 310 at a second timing t2 of the high period. The second timing t2 is delayed from the first timing t1 by a first time.

The timing control part 120 may read right eye open data corresponding to an opening of the right eye shutter 320 at a third timing t3 of a low period in which the 3D synchronized signal Sync has the low level, and the timing control part 120 may read right eye close data corresponding to a closing of the right eye shutter 320 at a fourth timing t4 of the low period. The fourth timing t4 is delayed from the third timing t3 by a second time.

Each of the left eye open data, the right eye open data, the left eye close data and the right eye close data may have data values including a plurality of bits. In one exemplary embodiment, for example, each of the left eye open data, the right eye open data, the left eye close data and the right eye close data may be 3-bit data including at least a first bit, a second bit and a third bit.

The first bit of the data, which is one of the left eye open data, the right eye open data, the left eye close data and the right eye close data, may have shutter control input information, the second bit of the data may have identification information of the left eye shutter or the right eye shutter, and the third bit may have identification information of opening and/or closing of left eye shutter or the right eye shutter. When the first bit of the data is “0”, the data do not have the shutter control input information, and when the first bit is “1”, the data have the shutter control input information. When the second bit of the data is “0”, the data are for the left eye shutter, and when the second bit of the data is “1”, the data are for the right eye shutter. When the third bit of the data is “0”, the data is corresponding to the opening of the left eye shutter or the right eye shutter, and when the third bit of the data is “1”, the data is corresponding to the closing of the left eye shutter or the right eye shutter.

In one exemplary embodiment, for example, when a value of the data is “100”, the data are left eye open data corresponding to the opening of the left eye shutter 310. When the value of the data is “101”, the data are left eye close data corresponding to the closing of the left eye shutter 310. When the value of the data is “110”, the data are right eye open data corresponding to the opening of the right eye shutter 320. When the value of the data is “111”, the data are right eye close data corresponding to the closing of the right eye shutter 320. In such an embodiment, the values of the data are “100, 101, 110 and 111”, for example, but the values of the data are not limited thereto.

The transmitter 200 may be an infrared light (“IR”) transmitter or a radio frequency (“RF”) transmitter. The transmitter 200 includes a modulating part 210 and a transmitting part 220.

In an exemplary embodiment, in which the transmitter 200 is the IR transmitter, the modulating part 210 modulates the left eye shutter control data LS_DATA and the right eye shutter control data RS_DATA with a pulse width modulation (“PWM”). The modulating part 210 generates a pulse having a width of about 20 microseconds (μs) when the bits of the left eye shutter control data LS_DATA and the right eye shutter control data RS_DATA are “1”. The modulating part 210 synchronizes the left eye shutter control data LS_DATA and the right eye shutter control data RS_DATA, whose pulse widths are modulated, with the 3D stereoscopic image synchronized signal to generate the left eye shutter control signal LSS and the right eye shutter control signal RSS, respectively. The transmitter 220 transmits the left eye shutter control signal LSS and the right eye shutter control signal RSS to the receiver 330.

In an alternative exemplary embodiment, in which the transmitter 200 is the RF transmitter, the modulating part 210 may modulate the left eye shutter control data LS_DATA and the right eye shutter control data RS_DATA with an amplitude shift keying (“ASK”), a frequency shift keying (“FSK”) or a phase shift keying (“PSK”). The modulating part 210 may carry the left eye shutter control data LS_DATA and the right eye shutter control data RS_DATA to a first carrier frequency and a second carrier frequency different from each other, respectively, and synchronize the left eye shutter control data LS_DATA and the right eye shutter control data RS_DATA, whose pulse widths are modulated, with the 3D stereoscopic image synchronized signal, respectively. Thus, the modulating part 210 may generate the left eye shutter control signal LSS and the right eye shutter control signal RSS.

The receiver 330 may be an IR receiver or a RF receiver. The receiver 330 includes a receiving part 331 and a restoring part 332.

The receiving part 331 receives the left eye shutter control signal LSS and the right eye shutter control signal RSS from the transmitter 200. The restoring part 332 demodulates and decodes the left eye shutter control signal LSS and the right eye shutter control signal RSS to be restored as original left eye shutter control data LS_DATA and original left eye shutter control data RS_DATA. The receiver 330 opens and/or closes the left eye shutter 310 and the right eye shutter 320 of the LC shutter glasses 300 based on the left eye shutter control data LS_DATA and the right eye shutter control data RS_DATA.

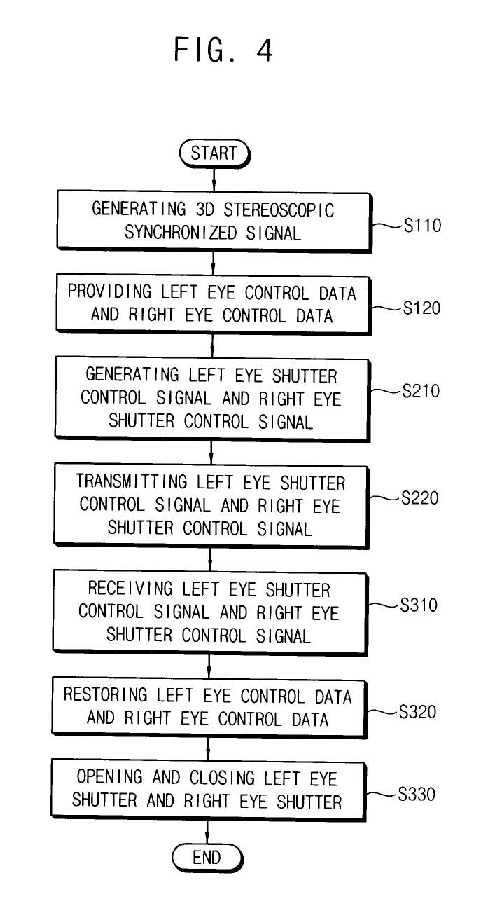

FIG. 4 is a flow chart illustrating an exemplary embodiment of a method of controlling the LC shutter glasses of FIG. 1.

Referring to FIGS. 2 and 4, the synchronized signal generating part 121 of the timing control part 120 receives the left eye image data L, the right eye image data R and the vertical synchronization signal V, and generates the 3D stereoscopic image synchronized signal Sync based on the left eye image data L, the right eye image data R and the vertical synchronization signal V (step S110).

Then, the timing control part 120 reads the left eye shutter control data LS_DATA stored in the memory 122 of the timing control part 120 to provide the left eye shutter control data LS_DATA to the transmitter 200 when the 3D stereoscopic image synchronized signal Sync has the high level, and reads the right eye shutter control data RS_DATA stored in the memory 122 to provide the right eye shutter control data RS_DATA to the transmitter 200 when the 3D stereoscopic image synchronized signal Sync has the low level (step S120).

The modulating part 210 of the transmitter 200 receives the left eye shutter control data LS_DATA to modulate the left eye shutter control data LS_DATA when the 3D stereoscopic image synchronized signal Sync has the high level, and receives the right eye shutter control data RS_DA to modulate the right eye shutter control data RS_DA when the 3D stereoscopic image synchronized signal Sync has the low level. The modulating part 210 of the transmitter 200 synchronizes the modulated left eye shutter control data LS_DATA and the modulated right eye shutter control data RS_DATA with the 3D stereoscopic image synchronized signal to generate the left eye shutter control signal LSS and the right eye shutter control signal RSS (step S210).

The transmitting part 220 of the transmitter 200 transmits the left eye shutter control signal LSS and the right eye shutter control signal RSS (step S220).

The receiving part 331 of the receiver 330 receives the left eye shutter control signal LSS and the right eye shutter control signal RSS from the transmitter 200 (step S310).

The restoring part 332 of the receiver 330 demodulates the left eye shutter control signal LSS and the right eye shutter control signal RSS to restore the left eye shutter control data LS_DATA and the right eye shutter control data RS_DATA (step S320). The restoring part 332 of the receiver 330 decodes the left eye shutter control data LS_DATA and the right eye shutter control data RS_DATA to open and/or close the left eye shutter 310 and the right eye shutter 320 (step S330).

According to the present exemplary embodiment of FIG. 1, the receiver 200 receives the left eye shutter control data and the right eye shutter control data in digital form corresponding to a controlling of the opening and the closing of the left eye shutter and the right eye shutter, to generate the simple shutter control signal. Thus, a false recognition in the shutter glasses is effectively prevented.

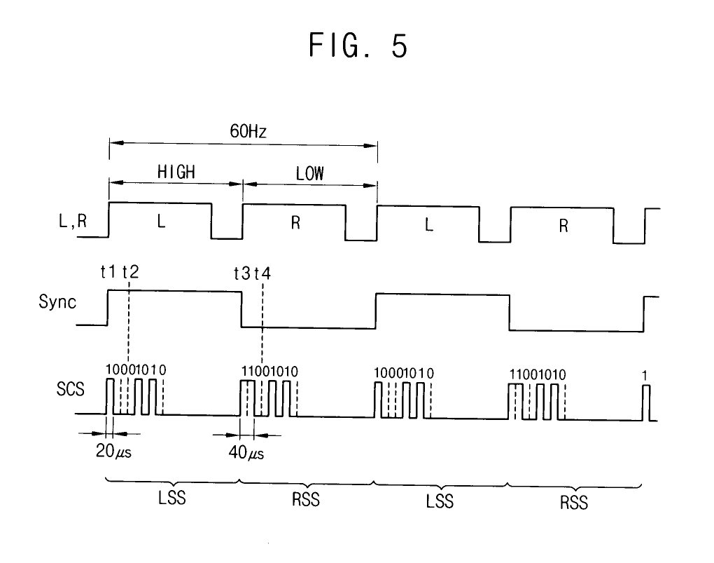

FIG. 5 is a signal timing diagram illustrating a stereoscopic image synchronization signal and a shutter controlling signal in an alternative exemplary embodiment of a display system according to the invention.

The signals in FIG. 5 are substantially the same as the signals of FIG. 3 except for timings thereof. Thus, the same reference numerals will be used to refer to the same or like parts as those described in the previous exemplary embodiment of FIG. 1, and any repetitive explanation concerning the above elements will be omitted.

Referring FIG. 5, a timing control part 120 may read left eye open data corresponding to the opening the left eye shutter 310 at a first timing t1 of a high period HIGH in which a 3D stereoscopic synchronized signal Sync has a high level. Then, the timing control part 120 may read left eye open time control data corresponding to a controlling of an open time of the left eye shutter 310 at a second timing t2 of the high period HIGH. The second timing t2 is delayed from the first timing t1 by a first time.

The timing control part 120 may read right eye open data corresponding to the opening of the right eye shutter 320 at a third timing t3 of a low period LOW in which the 3D stereoscopic synchronized signal Sync has a low level. Then, the timing control part 120 may read right eye open time control data corresponding to a controlling of the open time of the right eye shutter 320 at a fourth timing t4 of the low period LOW. The fourth timing t4 is delayed from the third timing t3 by a second time.

Each of the left eye open data, the right eye open data, the left eye open time control data and the right eye open time control data may have data values including a plurality of bits. In one exemplary embodiment, for example, each of the left eye open data and the right eye open data are 3-bit data including at least a first bit, a second bit and a third bit, and each of the left eye open time control data and the right eye open time control data are 5-bit data including a fourth bit, a fifth bit, a sixth bit, a seventh bit and an eighth bit.

The first bit may have shutter control input information, the second bit may have identification information of the left eye shutter or the right eye shutter, and the third bit may have identification information of opening or closing of the shutters. The fourth to eighth bits may have information of the open time of the shutters.

When the first bit of the data is “0”, the data do not have the shutter control input information, and when the first bit of the data is “1”, the data have the shutter control input information. When the second bit of the data is “0”, the data are for the left eye shutter, and when the second bit of the data is “1”, the data are for the right eye shutter. When the third bit of the data is “0”, the data is corresponding to the opening of the left eye shutter or the right eye shutter, and when the third bit of the data is “1”, the data is corresponding to the closing of the left eye shutter or the right eye shutter.

The fourth to eight bits may include information of the open times of the left eye shutter 310 and the right eye shutter 320, which are preset to reduce the crosstalk. Thus, the opening and/or closing of the left eye shutter 310 and the right eye shutter 320 is effectively controlled.

In one exemplary embodiment, for example, when a value of the data is “10001010”, the data are the left eye open data and the left eye open time control data corresponding to the opening of the left eye shutter 310 during a third time. When the value of the data is “11001010”, the data are the right eye open data and the right eye open time control data corresponding to the opening of the right eye shutter 320 during the third time. In such an embodiment, the values of the data are “10001010, 11001010”, but the values of the data is not limited thereto.

According to the exemplary embodiment of FIG. 5, the transmitter 200 receives the left eye shutter control data and the right eye shutter control data in digital form corresponding to the controlling of the opening and the open time of the left eye shutter and the right eye shutter to generate a simple shutter control signal, such that false recognition in the LC shutter glasses is thereby effectively prevented.

In an exemplary embodiment, a timing control part provides shutter control data in digital form from an external device to the transmitter, such that the transmitter may generate a substantially simple shutter control signal.

In an exemplary embodiment, the transmitter transmits the simple shutter control signal to a receiver, such that the receiver may has a substantially simple structure.

In an exemplary embodiment, the opening and the closing of a left eye shutter and a right eye shutter is controlled using the shutter control data, such that the left eye shutter may be prevented from being opened during the right eye shutter is open.

In an exemplary embodiment, the opening and the open time of the left eye shutter and the right eye shutter are controlled using the shutter control data, such that a visible characteristic is substantially improved. Thus, the open time of the left eye shutter and the right eye shutter is effectively optimized

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of controlling liquid crystal (LC) shutter glasses, the method comprising:
generating a three-dimensional (3D) stereoscopic image synchronization signal based on left eye image data and right eye image data;
generating left eye shutter control data and right eye shutter control data synchronized with the 3D stereoscopic image synchronization signal, wherein the left eye shutter control data and the right eye shutter control data are in digital form;
modulating the left eye shutter control data and the right eye shutter control data to generate a shutter control signal; and
controlling the LC shutter glasses based on the shutter control signal.

2. The method of claim 1, wherein the generating the left eye shutter control data and the right eye shutter control data comprises:
generating the left eye shutter control data when the 3D stereoscopic image synchronized signal has a high level; and
generating the right eye shutter control data when the 3D stereoscopic image synchronized signal has a low level.

3. The method of claim 2, wherein the generating the left eye shutter control data when the 3D stereoscopic image synchronized signal has the high level comprises:
generating left eye open data corresponding to an opening of a left eye shutter of the LC shutter glasses at a first timing of a high period, during which the 3D stereoscopic image synchronized signal has the high level; and
generating left eye close data corresponding to a closing of the left eye shutter of the LC shutter glasses at a second timing delayed from the first timing.

4. The method of claim 3, wherein the generating the right eye shutter control data when the 3D stereoscopic image synchronized signal has the low level comprises:
generating right eye open data corresponding to an opening of a right eye shutter of the LC shutter glasses at a third timing of a low period, during which the 3D stereoscopic image synchronized signal has the low level; and
generating right eye close data corresponding to a closing of the right eye shutter of the LC shutter glasses at a fourth timing delayed from the third timing.

5. The method of claim 4, wherein
each of the left eye open data, the left eye close data, the right eye open data and the right eye close data comprises a plurality of bits including a first bit, a second bit and a third bit,
the first bit includes shutter control identification information,
the second bit includes identification information of at least one of the left eye shutter and the right eye shutter, and
the third bit includes identification information of at least one of the opening of the left eye shutter, the closing of the left eye shutter, the opening of the right eye shutter and the closing of the right eye shutter.

6. The method of claim 2, wherein the generating the left eye shutter control data when the 3D stereoscopic image synchronized signal has the high level comprises:
generating left eye open data corresponding to an opening of a left eye shutter at a first timing of a high period in which the 3D stereoscopic image synchronized signal has the high level; and
generating left eye open time control data corresponding to a controlling of an open time of the left eye shutter at a second timing delayed from the first timing,
wherein the generating the right eye shutter control data when the 3D stereoscopic image synchronized signal has the low level comprises:
generating right eye open data corresponding to an opening of a right eye shutter at a third timing of a low period in which the 3D stereoscopic image synchronized signal has the low level; and
generating right eye open time control data corresponding to a controlling of an open time of the right eye shutter at a fourth timing delayed from the third timing.

7. The method of claim 6, wherein
each of the left eye open data and the right eye open data comprises a plurality of bits including a first bit, a second bit and a third bit,
each of the left eye shutter open time control data and the right eye shutter open time control data comprises a plurality of bits including a fourth bit, a fifth bit, a sixth bit, a seventh bit and an eighth bit,
the first bit includes shutter control identification information,
the second bit includes identification information of at least one of the left eye shutter and the right eye shutter, and
the third bit includes information of at least one of the opening of the left eye shutter, the closing of the left eye shutter, the opening of the right eye shutter and the closing of the right eye shutter.

8. The method of claim 1, wherein the generating the shutter control signal comprises:
modulating a pulse width of the left eye shutter control data to generate a left eye shutter control signal of the shutter control signal; and
modulating a pulse width of the right eye shutter control data to generate a right eye shutter control signal of the shutter control signal.

9. The method of claim 1, wherein the modulating the left eye shutter control data and the right eye shutter control data to generate the shutter control signal comprises:
modulating the left eye shutter control data using at least one of an amplitude shift keying, a frequency shift keying and a phase shift keying to generate a left eye shutter control signal of the shutter control signal; and
modulating the right eye shutter control data using at least one of the amplitude shift keying, the frequency shift keying and the phase shift keying to generate a right eye shutter control signal of the shutter control signal.

10. The method of claim 1, wherein the controlling the LC shutter glasses comprises:
receiving the shutter control signal including a left eye shutter control signal and a right eye shutter control signal;
restoring the left eye shutter control signal and the right eye shutter control signal to the left eye shutter control data and the right eye shutter control data, respectively; and
controlling a left eye shutter and a right eye shutter of the LC shutter glasses based on the left eye shutter control data and the right eye shutter control data, respectively.

11. A display system comprising:
a timing control part which generates a three-dimensional (3D) stereoscopic image synchronized signal based on left eye image data and right eye image data, and generates left eye shutter control data and right eye shutter control data in digital form synchronized with the 3D stereoscopic image synchronized signal;
a display panel which displays a 3D stereoscopic image using the left eye image data and the right eye image data;
a transmitter which modulates the left eye shutter control data and the right eye shutter control data to generate a shutter control signal; and
a receiver which controls a left eye shutter and a right eye shutter based on the shutter control signal.

12. The display system of claim 11, wherein the timing control part comprises:
a synchronized signal generating part which receives the left eye image data and the right eye image data, and generates the 3D stereoscopic image synchronized signal based on the left eye image data and the right eye image data; and
a memory which stores the left eye shutter control data and the right eye shutter control data,
wherein the timing control part reads the left eye shutter control data when the 3D stereoscopic image synchronized signal has a high level, and reads the right eye shutter control data when the 3D stereoscopic image synchronized signal has a low level.

13. The display system of claim 12, wherein the left eye shutter control data comprises a left eye open data corresponding to an opening of the left eye shutter and a left eye close data corresponding to a closing of the left eye shutter, and
the timing control part reads the left eye open data at a first timing of a high period, during which the 3D stereoscopic image synchronized signal has the high level, and reads the left eye close data at a second timing delayed from the first timing.

14. The display system of claim 13, wherein the right eye shutter control data comprises a right eye open data corresponding to an opening of the right eye shutter and a right eye close data corresponding to a closing of the right eye shutter, and
the timing control part reads the right eye open data at a third timing of a low period, during which the 3D stereoscopic image synchronized signal has the low level, and reads the right eye close data at a fourth timing delayed from the third timing.

15. The display system of claim 14, wherein each of the left eye open data, the left eye close data, the right eye open data and the right eye close data comprises at least first, second and third bits,
the first bit includes shutter control identification information,
the second bit includes identification information of at least one of the left eye shutter and the right eye shutter, and
the third bit includes information of at least one of the opening of the left eye shutter, the closing of the left eye shutter, the opening of the right eye shutter and the closing of the right eye shutter.

16. The display system of claim 12, wherein the left eye shutter control data comprises a left eye open data corresponding to an opening of the left eye shutter and a left eye shutter open time control data corresponding to a controlling of an open time of the left eye shutter,
the right eye shutter control data comprises a right eye open data corresponding to an opening of the right eye shutter and a right eye shutter open time control data corresponding to a controlling of an open time of the right eye shutter, and
the timing control part reads the left eye open data at a first timing of a high period, during which the 3D stereoscopic image synchronized signal has the high level, reads the left eye shutter open time control data at a second timing delayed from the first timing, reads the right eye open data at a third timing of a low period, during which the 3D stereoscopic image synchronized signal has the low level, and reads the right eye shutter open time control data at a fourth timing delayed from the third timing.

17. The display system of claim 16, wherein each of the left eye open data and the right eye open data comprises a first bit, a second bit and a third bit, and each of the left eye shutter open time control data and the right eye shutter open time control data comprises a fourth bit, a fifth bit, a sixth bit, a seventh bit and an eighth bit,
the first bit includes shutter control identification information,
the second bit includes identification information of at least one of the left eye shutter and the right eye shutter, and
the third bit includes information of at least one of the opening of the left eye shutter, the closing of the left eye shutter, the opening of the right eye shutter and the closing of the right eye shutter.

18. The display system of claim 11, wherein the transmitter comprises:
a modulating part which modulates pulse widths of the left eye shutter control data and the right eye shutter control data and generates a left eye shutter control signal and a right eye shutter control signal of the shutter control signal synchronized with the 3D stereoscopic image synchronized signal; and
a transmitting part which transmits the left eye shutter control signal and the right eye shutter control signal to the receiver.

19. The display system of claim 11, wherein the transmitter comprises:
a modulating part which modulates the left eye shutter control data and the right eye shutter control data using at least one of an amplitude shift keying, a frequency shift keying and a phase shift keying, and generates a left eye shutter control signal and a right eye shutter control signal of the shutter control signal synchronized to the 3D stereoscopic image synchronized signal, respectively; and
a transmitting part which transmits the left eye shutter control signal and the right eye shutter control signal to the receiver.

20. The display system of claim 11, wherein the receiver comprises:
a receiving part which receives a left eye shutter control signal and a right eye shutter control signal of the shutter control signal; and
a restoring part which restores the left eye shutter control signal and the right eye shutter control signal to the left eye shutter control data and the right eye shutter control data, respectively,
wherein the receiver controls the left eye shutter and the right eye shutter based on the left eye shutter control data and the right eye shutter control data, respectively.
